(19) United States
(12) Patent Application Publication
(10) Pub. No.: US 2005/0282555 A1
(43) Pub. Date: Dec. 22, 2005

(54) Control arrangement for point-to-multipoint user services in a mobile radio network

(75) Inventor: Joerg Swetina, A-Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/902,688

(22) Filed: Jul. 30, 2004

(30) Foreign Application Priority Data
Jun. 22, 2004 (DE) 20 2004 009 774.5

(51) Int. Cl. H04Q 7/20

(52) U.S. Cl. 455/454; 455/450

(57) ABSTRACT

A control arrangement for point-to-multipoint user services in a mobile radio network, wherein bearer services are used to transmit media data for user services and one and the same bearer service is used by more than one user service simultaneously in order to enable a more efficient use of bandwidth for identical data transmissions of different user services.

### CLAIM FOR PRIORITY

This application claims the benefit of priority to German Application No. 20 2004 009 774.5, which was filed in the German language on Jun. 22, 2004, the contents of which are hereby incorporated by reference.

### TECHNICAL FIELD OF THE INVENTION

The invention relates to a control arrangement for point-to-multipoint user services in a mobile radio network.

### BACKGROUND OF THE INVENTION

Point-to-multipoint services transmit data unidirectionally from a single individual data source to a plurality of destination units. Generally known examples of this are radio and television, where data is transmitted by a transmit antenna and can be received in the transmission area by an arbitrary number of receivers. In data networks such as, for example, the internet, corresponding “broadcast” and “multicast” methods are known. With the broadcast technology, datagrams are transmitted from a source to all potential receivers which fall, for example, within a specific IP address range. In the case of multicast, datagrams are transmitted from a source to a plurality of specific potential receivers; this technology is distinguished from broadcasting in that receivers can be specifically selected.

Broadcast and multicast are not very widely established as yet in the mobile radio area. However, it will be necessary for the future to specify such broadcast/multicast-enabled network nodes and the services that run on top of them. With the introduction of mobile radio networks of the third generation (for example UMTS networks), applications with high bandwidth requirements will also increasingly come to the fore. The corresponding services will very often consist in supplying a large number of users with the same data. Examples that come to mind here include, say, all kinds of regionally significant messages or communications which are to be transmitted simultaneously to all or certain users (mobile users) in a particular region.

Messages of this kind will include not only text data, but all types of media data, for example also video and audio data, i.e. they will also encompass multimedia applications. Since the bandwidth available for the data transmission via the radio interface cannot be expanded or extended indefinitely for physical and practical reasons, ways must be found here, but also in the mobile radio access and core network itself, to realize information distribution that is economical with bandwidth.

For this reason the technical specifications TS 22.146 “Multimedia Broadcast/Multicast Service”, TS 22.246 “Multimedia Broadcast/Multicast Service (MBMS) User Services” have been submitted by the 3GPP (“3rd Generation Partnership Project”, a standardization body for 3rd-generation mobile radio systems). The user services defined in TS 22.246 “User Services” make provision here for the transmission of media data from a media data source via the mobile radio network into a plurality of cells or, as the case may be, to mobile radio terminals located in these cells. For the transmission of media data of one data type (e.g. text, video, audio) via the mobile radio network through to the distribution in the cells of the coverage area, a user service or [lacuna] in each case uses as a basis an MBMS bearer service, the principal characteristics of which are defined in TS 22.146. Approaches to a network architecture for implementing MBMS user and bearer services for mobile radio networks are set down in TS 23.246.

As is known to a person skilled in the art, in the ISO/OSI protocol model a bearer service is sited in the bottom three protocol layers, while a user service, which sits on top of the bearer service, relates to all seven protocol layers. These interrelationships also apply to the bearer and user services discussed here. The bearer service control units are transparent to the transmitted data or data types, i.e. a bearer service can in principle transport any data of any data types; these are simply transmitted or transported by the bearer service, but the data passed to a starting point of the bearer service channel is output again unchanged at an end point of the channel.

The MBMS bearer services referred to transmit data between user network interfaces via the mobile radio network. With MBMS services, one of these interfaces is the interface to the media data source, in other words, for example, to a server of a data provider (“content provider”). The data source can be a part of the mobile radio network, but it can also be located outside the network, in which case the transmission of the data and transfer to the MBMS bearer service of the mobile radio network can take place, for example, via the internet.

The further interface of an MBMS bearer service is the radio interface, or more precisely the bottom three protocol layers for the radio interface as implemented in the mobile radio terminals. This relates in actuality to the Uu or Um interface.

A user service, on the other hand, extends from the content provider through to the user of the mobile radio terminal in a cell of the mobile radio network, or to put it more precisely across all seven protocol layers (including presentation layer) in the or from the media data server of the provider through to the presentation on the display of the mobile radio terminal.

According to the configuration of the MBMS user service, the data stream of one or more MBMS bearer services is presented to the user in the mobile radio terminal. If a number of MBMS bearer services are used for providing a user service, then the mobile radio terminal handles the synchronization of these data streams.

FIG. 1 illustrates by way of example the conditions for MBMS services which are formed in conformance with aforementioned specifications. The figure shows two user services X and Y. In this case the user service Y relies on a single transport or bearer service 3 for the transmission of audio data. Said service is embodied as a broadcast service, i.e. the audio data is transmitted by a “Multicast/Broadcast Service Center” (BM-SC, cf. TS 23.246) into a number of predefined cells of the mobile radio network, without users or subscribers of the service having to request registration or make their current location known to the network.

The user service X uses up to two bearer services 1 and 2 simultaneously. In the example shown in FIG. 1, text data is transferred initially via the bearer service 2. A short time later, audio data is transmitted via a further bearer service 1 and at the same time video data is transmitted via the bearer service 2. In the latter case the process may involve, for example, the transmission of video sequences at a few frames per second (“Low Quality Video” at 3 fps). The user service X uses multicast transmission. In this case the data is (only) transmitted into cells which contain currently registered users.

The MBMS bearer services defined in particular for UTRAN and GERAN networks reduce the bandwidth requirements for point-to-multipoint user services in the core network (i.e. between BM-SC, GGSN and SGSN), access networks (between SGSN, RNC and Node-B) and via the radio interface (through use of a common radio channel for a plurality of receivers or, as the case may be, mobile radio terminals in a cell).

As in the past, however, the use of bandwidth is unsatisfactory in a number of situations, specifically whenever there is a need for a number of user services to transmit at least part of the same data. This applies, for example, when a provider operates a specific basic service, but this basic service is implemented in different variants in the form of a plurality of actual user services. An example of this is a newsletter service for providing users with the latest news.

In a first variant (as first user service) only texts are transmitted. In a second variant (as second user service) the same text is also transmitted, but in addition so is image data, with the result that it becomes possible to display texts illustrated by figures. In this scheme the first user service could, for example, be offered at a cheaper price than the second, and for the content provider the number of customers (users) increases owing to the two different embodiments of what is essentially the same service.

However, the two user services would place a considerable load on the bandwidths available in the core network and via the radio interface of the mobile radio network, since the text portions of the newsletter have to be transmitted twice, whether in parallel or serially.

As is clear from the example, even with the implementation of MBMS services conforming to the 3GPP specifications, situations continue to exist in which massive use is made of bandwidths for the multiple transmission of identical data. This aspect stands in the way of the development of such services and of their acceptance by the mobile radio operators.

### SUMMARY OF THE INVENTION

The invention proposes a control arrangement and a control method for point-to-multipoint user services in a mobile radio network which enable a more efficient use of bandwidth for identical data transmissions of different user services.

According to the 3GPP specifications referred to above, an MBMS user service for the transmission of media data can use a number of bearer services or run on top thereof. A significant embodiment of the invention is to enable a plurality of user services to access the same bearer service simultaneously. Whereas previously the simultaneous transmission of identical data of two (or more) different user services in any case also required two (or more) bearer services, it is possible by means of control arrangements embodied according to the invention for two (or more) user services for which there is the requirement to transmit identical data for this data to be transmitted in fact once, and specifically via a bearer service used by both user services.

Here, a user service control unit for the transmission and distribution of media data of one data type in each case accesses a bearer service control unit in each case. According to the invention, a bearer service control unit is accessible to more than one user service control unit simultaneously.

The control units can be located in one or more BM-SCs. Bearer service control units are also required in or in association with further devices in the mobile radio network, via which devices the data is transmitted, for example GGSN, SGSN, RNC, Node-B. However, it is not necessary in relation to the invention for these control units to be modified.

By means of the invention the bandwidth requirements of a plurality of user services via which partially identical data is disseminated or distributed can be reduced. This increases the acceptance of corresponding user services among the network operators.

In preferred embodiments of the control arrangement according to the invention, at least two user service control units are embodied to access the same bearer service control unit, with at least one of the two user service control units being embodied to access a further bearer service control unit. The data to be transmitted of a user service can be fully used as part of a further user service which supplements said data with further data. Numerous combinations of such user services are enabled by the invention.

In such a development of the aforementioned embodiment, both user service control units are embodied to access a further bearer service control unit in each case. The further bearer services can relate to the transmission of data of the same or of a different data type, both with regard to one another and also with regard to the shared bearer service. Accordingly, the two user service control units can be embodied for access to the further bearer service control units for the transmission and distribution of media data of different data types.

In further embodiments of the control arrangement according to the invention, a storage device for storing context parameter sets is provided such that in each case a context parameter set can be assigned to a bearer service control unit, whereby a context parameter set comprises one or more parameters which specify the characteristics of a bearer service. By means of the invention the context concept can continue to be used advantageously for carrier services.

In developments of this embodiment, the user service control units are connected to the storage device in order in each case to retrieve a context parameter set for transmissions of media data of one data type and to access a bearer service control unit in accordance with the context parameters. The invention advantageously permits the further use of a controller of the bearer service control units that is slightly modified compared with the controller according to the specification.

In further developments of this embodiment, context parameters stored in the storage unit relate to the bandwidth of the transmitted volume of data and the quality of the data transmission. By this means the configuration of the shared bearer service can also be advantageously specified at a central point, that is to say in the context parameter set stored on the storage device.

In further embodiments of the control arrangement according to the invention each bearer service control unit is connected to a data input unit and a data output unit in order to receive data from the media data source via the data input unit and forward it via the data output unit to devices in the mobile radio network in accordance with the access by the user service control units. With the invention it is further possible to connect external or internal media data sources to the mobile radio network.

For the transmission of the data which is identical in the majority of the user services, the content provider provides one data stream or one data source, which reduces the bandwidth requirements between control arrangement and content provider. In a development of this embodiment, at least one bearer service control unit and one data input unit are embodied accordingly in order to receive data from a media data source outside of the mobile radio network, in particular from a media data server of a service provider.

In further embodiments of the control arrangement according to the invention, user service control units are embodied to transmit charge-related data to a charging device, in particular in the mobile radio network, in response to media data transmissions. By this means the invention continues to allow charging, both for broadcast and for multicast services. In a further development of the previously specified prior art, it can simply be necessary, for example, to correctly assign the data transmitted via the shared bearer service to the two or more user services, which then report their accounting data, in each case independently, to a charging server in the mobile radio network.

In further embodiments of the control arrangement according to the invention, user service control units are embodied to control the transmission of media data in such a way that in addition to the transmission via the bearer services, media data can also be transmitted to individual mobile radio terminals over point-to-point connections. By this means data which is transmitted via the shared bearer service can also be transmitted to terminal devices which, for example, report an error in transmission over the broadcast/multicast channel, without substantial loads being imposed on the network as a result of the retransmission over the broadcast/multicast channel.

The advantages and usefulness of methods according to the invention result from the advantages and usefulness of control arrangements according to the invention.

In still another embodiment of the invention, there is a method for controlling point-to-multipoint user services in a mobile radio network usually includes that bearer services are in each case used for data type-transparent transmission over the mobile radio network and distribution of the data in cells of the mobile radio network. User services are further used in each case to transmit media data of at least one data type from a media data source over the mobile radio network and to distribute said media data in cells of the mobile radio network in order to be received by a plurality of mobile radio terminals. In this case a user service uses one bearer service in each case for the transmission and distribution of media data of one data type in each case.

According to the invention, a method of this kind is developed further in such a way that a bearer service is used by more than one user service simultaneously.

In a preferred embodiment of the method according to the invention, out of two user services which use the same bearer service at the same time, one or both in each case also use a further bearer service to transmit data of different data types.

In a further aspect of these embodiments, the bearer service used by a plurality of user services is used in turn for the transmission and distribution of data of a different data type. Since carrier services are transparent to the transmitted data type, it is advantageously possible to specify a context for the carrier service, which context is suitable for the transmission of two different data types, for example in relation to the quality of the data transmission (the “Quality of Service”). This is also possible for the bearer service shared, according to the invention, by a plurality of user services.

In further embodiments of the method according to the invention, the user service retrieves context parameters of a stored context parameter set for the transmission of data of one data type and the bearer service is used in accordance with the context parameters. In one development the context parameters relate to a bandwidth of the transmitted data volume and a quality of the data transmission.

In further embodiments of the method according to the invention, media data is transmitted from a media data source outside the mobile radio network, with the transmission and distribution in the mobile radio network being controlled by the user service in accordance with the context parameters.

In still further embodiments of the method according to the invention, in response to a request from a mobile radio terminal the user service also transmits the media data to the mobile radio terminal over a point-to-point connection in addition to the transmission via the bearer service or services.

### BRIEF DESCRIPTION OF THE DRAWINGS

Further aspects, advantages and useful applications of the invention will become clear from the following description of the exemplary embodiments of the invention with reference to the figures, in which:

FIG. 1 shows the transmission of media data of two user services via a plurality of bearer services according to the prior art.

FIG. 2 shows a functional block diagram of a control arrangement embodied according to the invention.

FIG. 3 shows, in the same form as FIG. 1, the transmission of media data of a plurality of user services with inventive use of a common bearer service.

### DETAILED DESCRIPTION OF THE INVENTION

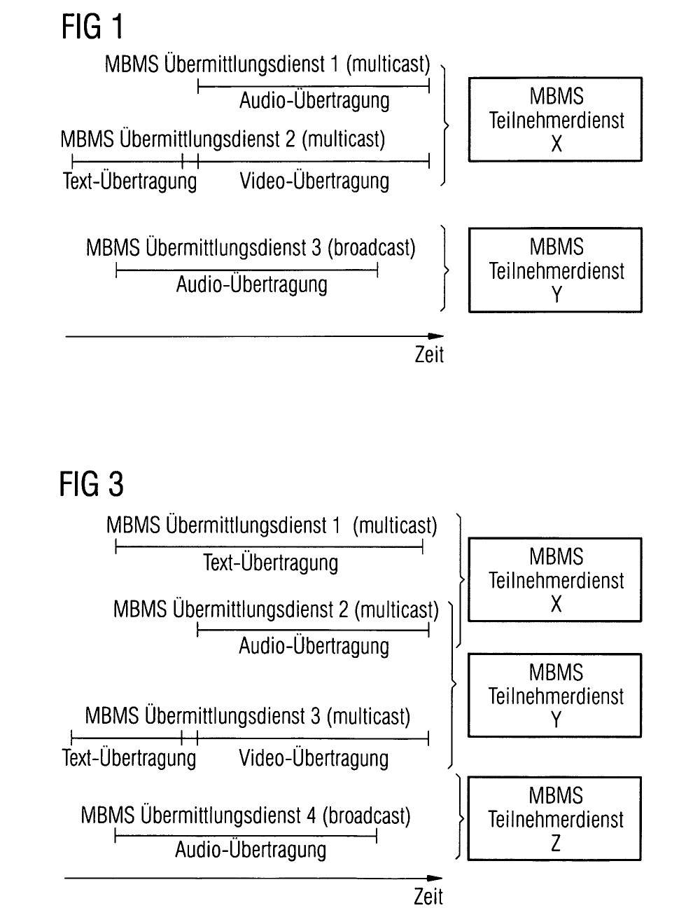

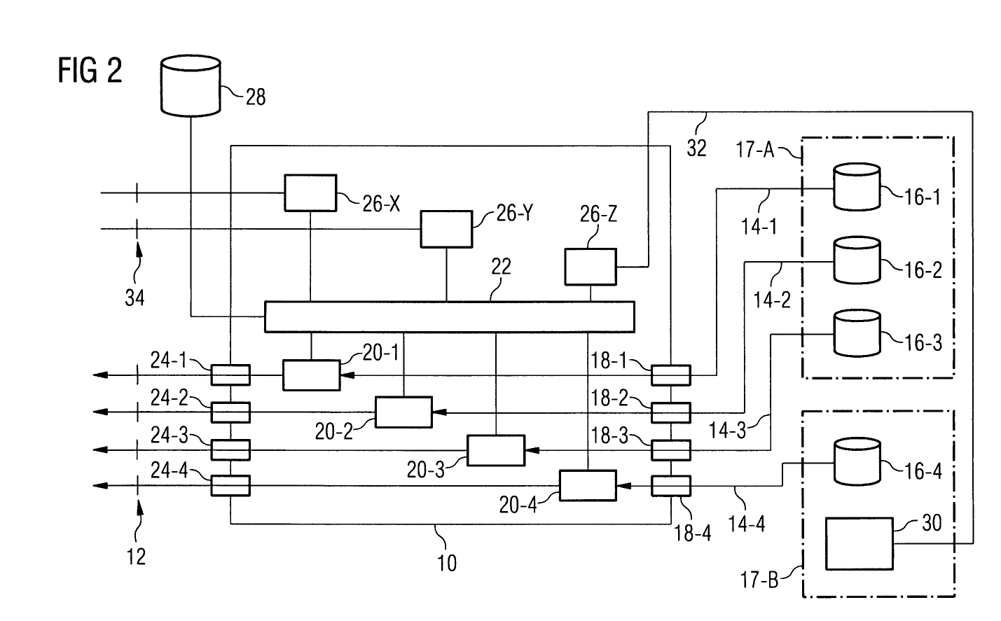

FIG. 2 shows in the form of a block diagram the functional layout of a broadcast/multicast service center (BM-SC) 10 further developed according to the invention, on which service center functionalities for MBMS users and bearer services are implemented in a third-generation mobile radio network in accordance with TS 23.246. The integration of a BM-SC into a mobile radio network, for example via the Gi interface 12, is described in detail in TS 23.246 (cf. in particular FIG. 1 in that document), so this description is known to a person skilled in the art and will not be repeated here.

The BM-SC 10 is connected via the Gi interface 12 to at least one GGSN of the mobile radio network and further via data connections 14-1 through 14-4 to a plurality of media data servers 16-1 through 16-4. These are assigned to a first media data provider 17-A (servers 16-1 through 16-3) and a second media data provider 17-B (“content provider”, server 16-4). The servers 16-1 through 16-4 lie outside the mobile radio network to which the BM-SC 10 belongs.

As is obvious to the person skilled in the art, the connections 14-1 through 14-4 can be permanently established connections, but preferably one of the connections 14-1 through 14-4 is set up as necessary between the BM-SC 10 and one of the media data servers 16-1 through 16-4, i.e. when data for a broadcast/multicast user service is to be retrieved and distributed over the mobile radio network. If this connection is set up via the internet, then in this case it is preferably an IP connection, for example an RTP/UDP/IP connection, as is known to be used for the transport of multimedia data (audio, video) over IP networks.

To receive data from the servers 16-1 through 16-4, the BM-SC 10 has a plurality of data input units 18-1 through 18-4 which are embodied for the reception of data over IP networks. The received data is forwarded to bearer service control units 20-1 through 20-4. These are selected by a resource manager or a resource management device 22 in a manner discussed in greater detail below and forward the media data in accordance with the selection to data output units 24-1 through 24-4. These output the data via the Gi interface 12. The data is forwarded by the receiving GGSN or GSSNs (depending on the coverage area of the carrier or bearer service) to one or more SGSNs into a UTRAN or GERAN and finally distributed in the cells of the mobile radio network that belong to the coverage area.

There are three user service control units 26-X through 26-Z in the BM-SC 10. A control unit of this kind can be present in the form of hardware and/or firmware, but preferably it is implemented purely in software, for example in the form of an instance of a class of control units, as is known to the person skilled in the art from the field of object-oriented programming. The three control units 26-X through 26-Z control the resource manager 22, as is described in more detail below. Initially, however, the interworking of user services and bearer services according to the invention will be described with reference to FIG. 3.

Similarly to the depiction in FIG. 1, FIG. 3 shows a schematic representation of three user services X, Y and Z which correspond to the control unit instances 26-X through 26-Z from FIG. 2.

For the transmission of multimedia data, the user service X uses at least temporarily two transport services 1 and 2, the user service Y at least temporarily the user services 2 and 3, and the user service Z exclusively the bearer service 4. The bearer services 1 through 4 correspond here to the bearer service control units 20-1 through 20-4 from FIG. 2. This is to be understood in the sense that one of the end-points of the bearer service 1 is located in the BM-SC 10 from FIG. 2, and more specifically in the bearer service control unit 20-1.

The control unit controls the data transmitted by the data server 16-1 and received via the data input unit 18-1 in such a way that a bandwidth and quality of data transmission predefined for the bearer service 1 is assured via the Gi interface 12. To that end, the control unit 20-1 has, for example, a buffer (not shown) in order to match the bandwidth received via the data input unit 18-1 to the predefined bandwidth via the Gi interface 12. The same applies to the further transport service control units 20-2 through 20-4.

The user service X from FIG. 3 uses the bearer service 1 for the transmission of text data. Some time after the start of the text transmission, the further bearer service 2 is attached in addition for the transmission of audio data for the user service X.

The user service X is a multicast service, i.e. the data transmitted by the bearer services 1 and 2 is only transmitted into such cells of the mobile radio network in which there are users of the user service X who have signaled to the network via their terminal device that they would like to receive data transmissions of the user service X, if any such data transmissions are available.

In the example, the user service X represents a newsletter service for displaying the latest message texts on the display of the receiving mobile radio terminals. For car drivers or persons who for other reasons cannot receive the text version of the message at the present time, the text is additionally transmitted in the form of audio data, which means that the users have the option of having the message texts read out to them.

As well as the user service X, the content provider 17-A offers a related user service Y, but one in which the latest news is played back using less text and with accompanying video image data (still images or low-quality video). The bearer service 3 is used for the transmission of the text and video data specific to the user service Y, as shown in FIG. 3. Here too, however, there should be the option allowing the user to have the messages read out to him.

In the conventional arrangement the service X would have to make use of two transport services 1 and 2, and the service Y two further transport services 3 and 4. In this case the service Y would transmit the identical audio data as the service X via its fourth transport service at the same time and into the same coverage area. In other words, two identical data streams would be transmitted via the Gi interface, further interfaces in the mobile radio core network and access network and over two radio channels seized in parallel to each cell of the coverage area of the services X and Y and would be distributed there.

According to the invention, however, the user services X and Y can share the same bearer service 2 for the transmission of their identical audio data. By this means the bandwidth requirements for the audio data of the user services X and Y that is to be transmitted are halved.

The shared use of or shared access to a common bearer service by different user services is described in detail below with reference to FIG. 2.

When a user service is set up in the BM-SC 10, an instance of a user service control unit is generated, for example the instance 26-Z. In the process numerous parameters are defined, for example a designation for the user service, the network address for the media data server(s) 16-4 of the content provider and in particular parameters which specify the bearer services that are to be used.

A bearer service is specified in this case by means of a context parameter set for which, in addition to an IP multicast address, in particular “Quality of Service” parameters and a distribution area in the mobile radio network are defined. A compilation of the context parameters of a context parameter set of this kind can be found in TS 23.246, section 6.2, table 2. The context parameter set of each bearer service for the newly defined user service Z, implemented by the control unit 26-Z, is stored possibly together with further user service-related parameters in a storage device 28 which is assigned to the BM-SC 10 and further BM-SCs of the mobile radio network. The device 28 could, however, equally well be an internal storage device in the BM-SC 10.

For the user service Z, the context parameter list or the context parameter set for the bearer service 4, i.e. the bearer service control unit 20-4, is to be stored in the device 28. If the content provider 17-B wants to transmit audio data as part of the user service Z (cf. FIG. 3), it transmits an initialization message to this effect from a central control device 30 of the content provider 17-B via a connection 32 to the user service control unit 26-Z.

In the example, the message transmitted via the connection 32 is an HTTP message which bears a designation for identifying the user service Z, for which a data transmission is pending. This designation was communicated to the provider 17-B following the setup of the control unit or instance 26-Z by the mobile radio operator.

In response to the initialization message transmitted by the provider 17-B via the connection 32, the control unit 26-Z sends a control command to the resource manager 22. The control command contains an identification of the context parameter set that was stored in the storage device 28 during the setup of the user service Z. This is read out by the resource manager 22, which instantiates an instance of a bearer service control unit, specifically the instance 20-4, by means of the values of the context parameters. The control unit 20-4 is thus embodied to control the bandwidth and quality parameters in accordance with the context parameters of the transmission of the audio data as part of the bearer service 4.

The resource manager 22 further reserves the data input unit 18-4 as well as the data output unit 24-4 for the bearer service 4. The units 18-4 and 24-4 are therefore no longer available to other bearer services.

Finally, the resource manager 22 passes the context parameter set or a part thereof to the user service control unit 26-Z. The latter transmits at least a part of the context parameter set in signaling messages via the Gmb interface 34 to a GGSN in the mobile radio network so that the GGSN reserves corresponding resources, i.e. instantiates control units similar to the bearer service control unit 20-4 and reserves the corresponding data input and output units. Corresponding signaling messages are transmitted from the GGSN to SGSNs and devices in the UTRAN access network, which thereupon likewise reserve corresponding resources.

Finally, a data transmission channel is reserved for the bearer service 4. Said channel begins at the control unit 20-4 in the BM-SC 10 and ends at a plurality of transmitting devices in access networks, in reality the “Node-B” devices in the “Radio Network System” of the UTRAN. The user service control unit 26-Z transmits a corresponding acknowledgement message to the server 30 of the content provider 17-B. The latter then prompts the media data server 16-4 to transmit audio data to the BM-SC 10, or more precisely to the input unit 18-4.

The user services X and Y represented schematically in FIG. 3 are set up in the same way as described above for the service Z. In particular a context parameter set is created in the storage device 28 for the user service X for the bearer service 1 and the bearer service 2 respectively, in each case with a specific identification specification.

Similarly, a bearer service 3 and also, according to the invention, the same bearer service 2 are stored for the user service Y in the storage device 28 in the form of a context parameter set in each case. Here, the context parameter set for the bearer service 2 has the same identifier both for the user service X and for the user service Y. Instead of explicitly storing the same context parameter set twice, the context parameter set for the bearer service 2 in relation to the user service Y could also, for example, be replaced by a link or pointer which points to the context parameter set for the bearer service 2 in relation to the user service X, in the manner that is known to the person skilled in the art.

In order to initiate data transmissions for the two user services X and Y, the control unit instances 26-X and 26-Y each receive an initialization message from a control device of the provider 17-A via connections (not shown in the drawing for reasons of clarity), in a similar way to that described above in relation to the connection 32 for the instance 26-Z. It is assumed that the initialization message for the control unit 26-X arrives first, followed immediately by that for the control unit 26-Y.

The control units X and Y both send a control command for setting up the bearer services 1 and 2, or 2 and 3 respectively, to the resource manager 22. The control command of the control unit 26-X should arrive at the resource manager 22 somewhat earlier than the control command of the control unit 26-Y. Then the context parameter set for the bearer service 1 and the bearer service 2 is read out first from the storage device 28 and the bearer service control units 20-1 and 20-2 are instantiated accordingly.

The resource manager 22 now receives the control command of the unit Y and is embodied according to the invention to detect that the context parameter set for the bearer service 2 has already been read out and a bearer service control unit 20-2 has already been instantiated. This detection is effected via the identical identification specification of the context parameter set. Thus, the context parameter set for a bearer service 3 is read out from the storage device 28 and the bearer service control unit 20-3 instantiated.

The acknowledgement message to the control units 26-X and 26-Y in each case includes the complete context parameter sets for the bearer services 1 and 2 (to the unit 26-X) and 3 (unit 26-Y), respectively. Instead of the context parameter set for the bearer service 2, a message is transmitted to the control unit 26-Y indicating that this bearer service has already been set up and will be shared. In response to this, the setting up of the channel for the bearer service 3 is triggered by the control unit 26-Y, while the control unit 26-X transmits the context parameter sets for the channels of the bearer services 1 and 2, in so far as is required for the reservation, in their entirety via the Gmb interface 34.

Thus, a conventional resource manager can be implemented in the GGSN and the following devices in which channels are to be reserved for the bearer services 1, 2, 3, which resource manager reserves the channels for the bearer services 1, 2, 3 in the known way.

According to traditional methods, a channel for a further bearer service would have to be set up for the audio data transmission within the framework of the user service Y, and more specifically from the BM-SC 10 through to the Node-Bs in the cells of the coverage area of the service Y. This is rendered superfluous by the shared use of the bearer service 2 implemented by the bearer service control unit 20-2.

Although the input units 18-1 through 18-4 are drawn as separate units in FIG. 2, these can be present in actual hardware terms in the form, for example, of a single network interface card. The same applies to the data output units 24-1 through 24-4. Thus, the units 18-1-18-4 and 24-1-24-4 respectively can, for example, represent individual ports of a common network address implemented by means of the interface card. The link between the interface card for the data input and the interface card for the data output is established by the control units 20-1 through 20-4 which are preferably implemented in a central processor unit of the BM-SC 10.

The resource manager 22 is also preferably present in the form of software which is executed on the central processor unit. It is, however, equally possible that each of the user service control units on 26-X through 26-Z is in each case present as software on independent hardware units and that the resource manager 22 is also present distributed over the hardware of the control units 26-X through 26-Z. Similarly, the bearer service control units 20-1 through 20-4 can also be present on a plurality of hardware units. Thus, for example, the user service control unit for the user service X, a subunit of the resource manager and the bearer service control units for the bearer services 1 and 2 could be present on one BM-SC, the user service control unit for the user service Y, a further subunit of the resource manager and the bearer service control unit for the bearer service 3 could be present on a second BM-SC, and the user service control unit for the user service Z, a still further subunit of the resource manager and the bearer service control unit for the bearer service 4 could be present on a third BM-SC.

Mobile radio terminals which are designed for the reception of MBMS user services do not need to be modified in order to receive broadcast/multicast data via a mobile radio network embodied according to the invention.

Above and beyond the embodiments and variations described here, many more further embodiments are conceivable by competent action on the part of a person skilled in the art within the scope of the invention which is specified exclusively by the following claims.

1. A control arrangement for point-to-multipoint user services in a mobile radio network, comprising:
a plurality of bearer service control units for controlling, respectively, a bearer service for the transmission of data, the transmission being transparent in relation to data types, over the mobile radio network and distribution of the data in cells of the mobile radio network; and
a plurality of user service control units for controlling, respectively, a user service in which media data of at least one data type is transmitted from a media data source over the mobile radio network and distributed in cells of the mobile radio network to be received by a plurality of mobile radio terminals,
wherein the user service control unit for the transmission and distribution of media data of one data type in each case accesses the bearer service control unit respectively, and
the same bearer service control unit is accessible to more than one user service control unit simultaneously.

2. The control arrangement according to claim 1, wherein
at least two user service control units are embodied to access the same bearer service control unit, with at least one of the two user service control units being embodied to access a further bearer service control unit.

3. The control arrangement according to claim 2, wherein
the two user service control units are in each case embodied to access a further bearer service control unit respectively.

4. The control arrangement according to claim 3, wherein
the two user service control units for accessing the further bearer service control units are embodied for the transmission and distribution of media data of different data types.

5. The control arrangement according to, claim 1, further comprising
a resource management device, via which the user service control units access the bearer service control units, and is embodied to manage the simultaneous access by two or more user service control units the same bearer service control unit.

6. The control arrangement according to, claim 1, further comprising
a storage device to store context parameter sets in such that in each case one context parameter set can be assigned to the bearer service control unit, whereby a context parameter set comprises one or more parameters which specify characteristics of a bearer service.

7. The control arrangement according to claim 6, wherein
the user service control units are connected to the storage device to retrieve a context parameter set in each case for transmissions of media data of a data type and to access the bearer service control unit in accordance with the context parameters.

8. The control arrangement according to claim 7, wherein
context parameters stored in the storage unit relate to a bandwidth of the transmitted data volume and a quality of the data transmission.

9. The control arrangement according to, claim 1, wherein
each bearer service control unit is connected to a data input unit and a data output unit in order to receive data from the media data source via the data input unit and forward the data via the data output unit to devices in the mobile radio network in accordance with the access by the user service control units.

10. The control arrangement according to claim 9, wherein
at least one bearer service control unit and one data input unit are embodied to receive data from a media data source outside the mobile radio network from a media data server of a service provider.

11. The control arrangement according to claim 1, wherein
user service control units are embodied to transmit charge-related data to a charging device in the mobile radio network, in response to media data transmissions.

12. The control arrangement according to claim 1, wherein
user service control units are embodied to control the transmission of media data such that in addition to the transmission via the bearer services, media data can also be transmitted to individual mobile radio terminals over point-to-point connections.

13. A method for controlling point-to-multipoint user services in a mobile radio network, comprising:
transmitting data using bearer services, transparent in relation to data types, over the mobile radio network and distribution of the data in cells of the mobile radio network;
transmitting, in each case, media data of at least one data type via user services from a media data source over the mobile radio network and distributed in cells of the mobile radio network to be received by a plurality of mobile radio terminals; and
transmitting and distributing, using the user service in each case the bearer service of media data of one data type in each case, wherein
the same bearer service is used by more than one user service simultaneously.

14. The method according to claim 13, wherein
out of two user services which use the same bearer service at the same time, one or both in each case also use a further bearer service to transmit data of different data types.

15. The method according to claim 13, wherein
the bearer service used by a plurality of user services is used in turn for the transmission and distribution of data of a different data type.

16. The method according to one of the claims 13, wherein
the user service retrieves context parameters of a stored context parameter set for the transmission of data of one data type and the bearer service is used in accordance with the context parameters.

17. The method according to claim 16, wherein
the context parameters relate to a bandwidth of the transmitted data volume and a quality of the data transmission.

18. The method according to one of the claims 13, wherein
media data is transmitted from a media data source outside the mobile radio network, with the transmission and distribution in the mobile radio network being controlled by the bearer service in accordance with the context parameters.

19. The method according to one of the claims 13, wherein
in response to a request from a mobile radio terminal the user service also transmits media data to the mobile radio terminal over a point-to-point connection in addition to the transmission via the bearer service or services.
